(19) United States
(12) Patent Application Publication
(10) Pub. No.: US 2015/0286402 A1
(43) Pub. Date: Oct. 8, 2015

(54) LIVE NON-VISUAL FEEDBACK DURING PREDICTIVE TEXT KEYBOARD OPERATION

(71) Applicant: QUALCOMM Incorporated, San Diego, CA (US)

(72) Inventors: Joel T. BEACH, Sydney (AU); Anthony D. MORIARTY, Sydney (AU); Matthew Christian DUGGAN, Tokyo (JP)

(73) Assignee: QUALCOMM Incorporated, San Diego, CA (US)

(21) Appl. No.: 14/248,193

(22) Filed: Apr. 8, 2014

(51) Int. Cl. G06F 3/0488

(52) U.S. Cl. CPC G06F 3/04886

(57) ABSTRACT

A device in which a user enters characters by using a soft keyboard, the device including a prediction engine to predict likely words as the user taps or swipes on the soft keyboard, the device providing non-visual feedback in response to a confidence level based upon the soft keyboard input as the user types out a word.

### FIELD OF DISCLOSURE

The disclosure pertains to devices with soft keyboards.

### BACKGROUND

Many devices, such as mobile phones and tablets, have available an on-screen or soft keyboard. When using a soft keyboard, usually a user enters characters (e.g., letters, numerals, punctuation symbols) by tapping on soft keys one by one (a tap-style keyboard), or by moving a finger in fluid motion from one soft key to another (a swipe-style keyboard). Predictive technology is utilized by the mobile phone or tablet as a user enters characters using a soft keyboard, with sophisticated algorithms employed to predict a word before the user has completed typing out the word.

For tap-style keyboards, usually users are very focused on looking at the keys as they type, and do not look at the screen to see how the phone or tablet is interpreting their key presses until reaching the end of a word or sentence. Often, this requires users to backtrack and re-enter words if the predictive technology incorrectly predicts a word.

On swipe-style keyboards, present devices provide no live feedback during the swiping motion, often resulting in a user swiping entire words even if the correct word is predicted halfway through the motion. Although some devices with swipe-style keyboards offer suggestions in the middle of a word, it is difficult for the user to visually track the current suggestion while typing at the same time.

### SUMMARY

Exemplary embodiments of the disclosure are directed to systems and methods for live non-visual feedback during predictive text keyboard operation.

In an embodiment, a method provides feedback with a mobile device having a soft keyboard. The method comprises: generating a confidence level based on receiving a set of taps or locus of sensed positions on a soft keyboard; generating a set of candidate words in a dictionary based on the set of taps or locus of sensed positions; generating the confidence level as a function of the size of the set of candidate words; and providing feedback with the mobile device based on the generated confidence level

In another embodiment, an apparatus comprises: at least one processor; a display; a haptic feedback unit; and a memory to store instructions that when executed by the at least one processor cause the apparatus to perform a procedure comprising: generating a confidence level based on receiving a set of taps or locus of sensed positions on a soft keyboard displayed on the display; generating a set of candidate words in a dictionary based on the set of taps or locus of sensed positions; generating the confidence level as a function of the size of the set of candidate words; and providing feedback with the haptic feedback unit based on the generated confidence level.

In another embodiment, a non-transitory computer readable medium has stored instructions that when executed by at least one processor cause a mobile device to perform a method comprising: generating a confidence level based on receiving a set of taps or locus of sensed positions on a soft keyboard displayed on the mobile device; generating a set of candidate words in a dictionary based on the set of taps or locus of sensed positions; generating the confidence level as a function of the size of the set of candidate words; and providing feedback with the mobile device based on the generated confidence level.

### BRIEF DESCRIPTION OF THE DRAWINGS

The accompanying drawings are presented to aid in the description of various embodiments and are provided solely for illustration of the embodiments and not limitation thereof.

FIG. 1 illustrates a mobile device in which embodiments may find application.

FIG. 2 illustrates a soft keyboard employing a swipe-style sensor in which embodiments may find application.

FIG. 3 is a flow diagram according to an embodiment.

FIG. 4 illustrates a wireless communication system in which embodiments may find application.

### DETAILED DESCRIPTION

The description and related drawings are directed to specific embodiments. Alternate embodiments may be devised without departing from the scope of the disclosure. Additionally, well-known elements will not be described in detail or will be omitted so as not to obscure relevant details.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of any embodiments. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, various embodiments may take a number of different forms, all of which have been contemplated to be within the scope of the claimed subject matter. In addition, for each of the embodiments described herein, the corresponding form of any such embodiments may be described herein as, for example, “logic configured to” perform the described action.

Embodiments of the disclosure communicate to the user a level of confidence in word prediction as the user types out words in a soft keyboard. This communication is live in the sense that it is done in real-time, or near real-time, as the user enters characters by typing on a soft keyboard. This communication may be performed in a non-visual way to provide feedback indicative of the word prediction in such as manner as to not break a user's visual concentration when tapping or swiping the keys of the soft keyboard.

For some embodiments, the feedback communication may indicate either a low level of confidence, or a high level of confidence. A user may utilize feedback indicating a low level of confidence by quickly looking at the screen to see if the word prediction is correct, and if not correct, then re-entering the word but in a more careful fashion. A user may utilize feedback indicating a high level of confidence by immediately moving on to the next word, or perhaps moving on to the next word only after quickly checking as to whether the intended word has been correctly predicted.

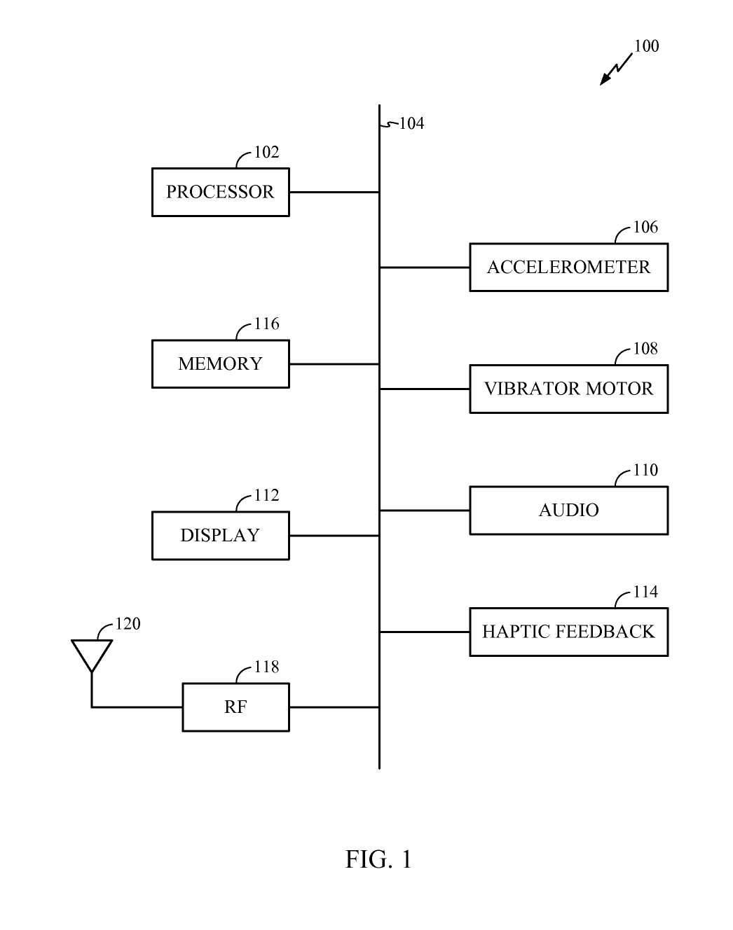

FIG. 1 illustrates a device 100 in which embodiments may find application. The device 100 may be a cellular phone, a tablet, a computer system, or any other type of mobile communication device. The functional unit 102 represents one or more processors, and is referred to as the processor 102. The processor 102 communicates with various other functional units by way of system bus 104. For example, shown in FIG. 1 are an accelerometer 106, a vibrator motor 108, an audio device 110, a display 112, a haptic feedback unit 114, and a radiofrequency module 118 coupled to an antenna 120. A memory hierarchy, represented by a memory 116, stores data and executable instructions for the processor 102.

It is to be understood that the functional units illustrated in FIG. 1 also include interface or driver circuits as well as driver software. Furthermore, it is to be understood that some of the functional units illustrated in FIG. 1 may represent a one or more components to achieve some particular function. For example, the vibrator motor 108 may represent a plurality of such motors so that the mobile device 100 may be caused to vibrate in various ways, such as for example where a particular side of the mobile device 100 vibrates more than an opposite side.

The representation of the architecture of the device 100 by the functional units illustrated in FIG. 1 is not meant to be a rigid view of the various functional units and their interactions. For example, various hardware components of the haptic feedback unit 114 may be viewed as residing in the display 112, or similarly, the vibrator motor 108 may be viewed as being part of the haptic feedback unit 114.

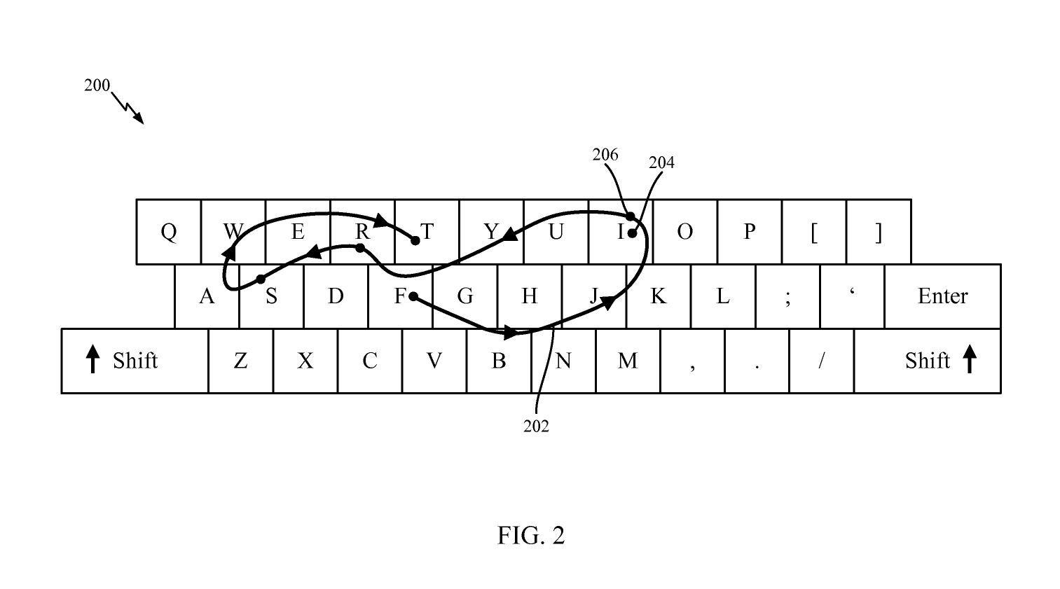

A soft keyboard may be displayed on the display 112 by which a user may enter various characters that are interpreted by the device 100. FIG. 2 provides a simplified representation of a soft keyboard 200 employing a swipe-style sensor. The soft keyboard 200 may be referred to as a swipe-style keyboard. For ease of illustration, not all soft keys in a typical soft keyboard are necessarily shown. FIG. 2 demonstrates the spelling of the word first. The line 202 is the locus of positions on the swipe-style keyboard 202 for which a user might trace out the characters for spelling the word first. The solid dots in FIG. 2 represent where a user might pause during the swipe motion to indicate a particular character.

When using a soft keyboard, the confidence associated with the word prediction may be a function of the number of eligible (candidate) words available in a dictionary (set) of words. In a swipe-style keyboard, the confidence may also be a function of how closely the letters of the candidate words match the curve (locus of finger positions) of the user's motion on the swipe-style keyboard. For example, the positions where a user pauses on a key may be compared to the respective centers of the keys. As a particular example, in FIG. 2 the center of the soft key for the letter I is represented by the position labeled 204, and the position where the user briefly paused on the soft key for the letter I is represented by the position labeled 206. The distance between the positions 204 and 206, as well as similar distances for the other soft keys making up the word first, may be used in computing a confidence value.

For example, if the distance associated with a particular soft key is large in the sense that it is comparable to one-half of the width or height of a soft key, then the user may not have meant to pause on that particular soft key even though a prediction engine running on the processor 102 may have used the letter for that particular soft key as part of the intended word. Accordingly, the confidence value may be decreased based upon the number of soft keys for which the distance between the sensed position and the geometric center is greater than some threshold, where the threshold is comparable to one-half of the width or height of a soft key. Similarly, for a tap-style keyboard, the confidence value may also be a function of a metric based upon distances between the taps on the soft keys from their respective geometric centers.

Embodiments may utilize an upper threshold of confidence and a lower threshold of confidence when determining whether feedback is to be provided to the user. When the confidence falls outside the range defined by the upper and lower confidence thresholds, an embodiment notifies the user by a non-visual communication. Examples of such communications may include audio, a vibration pattern, or electro-vibratory haptic feedback. The cues provided to the user may be different depending upon whether the confidence level is too low (less than the lower confidence threshold) or too high (greater than the upper confidence threshold).

Too high a confidence may imply that the user can stop typing so that a predictive engine running on the processor 102 can complete auto-typing of the predicted word. Too low a confidence may imply that there is not a good word match or that the predictive engine is unlikely to predict the correct word, and accordingly the user may wish to revise their finger motion when using a swipe-type keyboard, or perhaps increase their accuracy with a tap-style keyboard.

In another embodiment, the level of confidence communicated to the user may comprise more than the two levels as discussed above, so that the level of confidence is communicated in an analog fashion. For example, the user holding a mobile phone may experience the phone vibrating on the left-hand side when the confidence level is low, and the vibration may move to the right hand side of the mobile phone as the confidence level increases. The vibration may be accomplished with one or more piezoelectric actuators. For example, multiple actuators may be employed to provide vibrations that are sensed by the user as moving from left to right, where the rightmost side indicates the highest level of confidence and the leftmost side the lowest level of confidence.

In another embodiment, for a swipe-style keyboard, electro vibration haptics may be employed to indicate a level of confidence that various soft keys represent the next correct letter in a word. For example, the feeling of friction that the user experiences when moving a finger toward a soft key may be reduced when with high confidence that soft key represents the correct next letter in the predicted word. Conversely, the feeling of friction may be increased in the direction of less-likely soft keys.

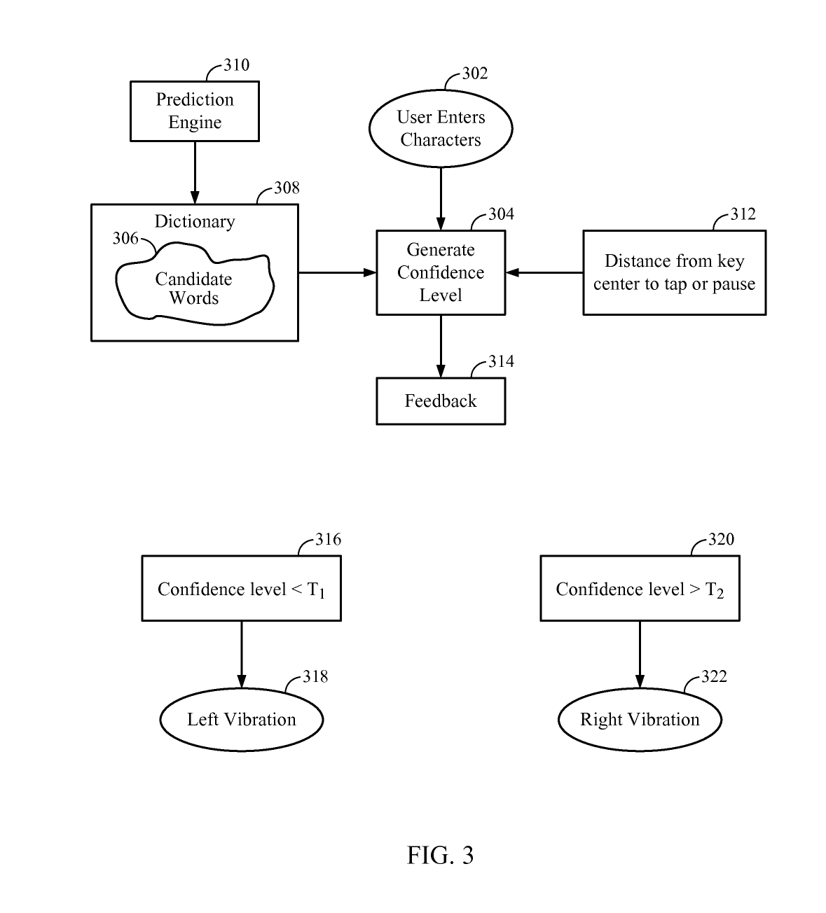

FIG. 3 is a flow diagram according to an embodiment. As a user enters characters using a soft keyboard (302), a confidence level is generated (304). The confidence level may be a function of the number of candidate words, where the confidence level increases as the size of the set of candidate words decreases. The set of candidate words is illustrated as the set 306 of words within the dictionary 308. A prediction engine 310 is used to provide the set of candidate words. The prediction engine 310 may be a process running on the processor 102, or it may be a special purpose processor.

The confidence level may also be a function of the distances between soft key centers and positions at which the user taps the soft key, or where the user pauses when using a swipe-style keyboard (312). These taps or pauses are positions in the locus of positions 202. Associated with a soft key in a character sequence is a position in the locus of positions 202. For example, the confidence level may be a function of the sum of distances |c(n)−u(n)|, where the index n denotes the n^{th} soft key in a character sequence, c(n) denotes the center of the n^{th} key, and u(n) denotes the associated position in the locus of positions 202. That is, it is the position at which the user presses the soft key or pauses with their finger when using a swipe-style keyboard. The sum is over the index n, and may be a weighted sum. The confidence level may then be chosen as a function of the sum (or weighted sum), where the confidence level increases as the sum of distances for a character sequence decreases.

Depending upon the confidence level, feedback (314) is provided. For some embodiments, the feedback may depend upon whether the confidence level is less than a first threshold or greater than a second threshold. An example is illustrated in FIG. 3 where if the confidence level is less than a first threshold (316) then the left hand side of the mobile device is made to vibrate (318), and if the confidence level is greater than a second threshold (320) then the right hand side of the mobile device is made to vibrate (322).

The actions indicated by the flow diagram of FIG. 3 may be performed in response to the processor 102 executing instructions stored in a non-transitory computer readable medium. The memory 116, which may represent system memory or a memory hierarchy, may be viewed as including the aforementioned non-transitory computer readable medium.

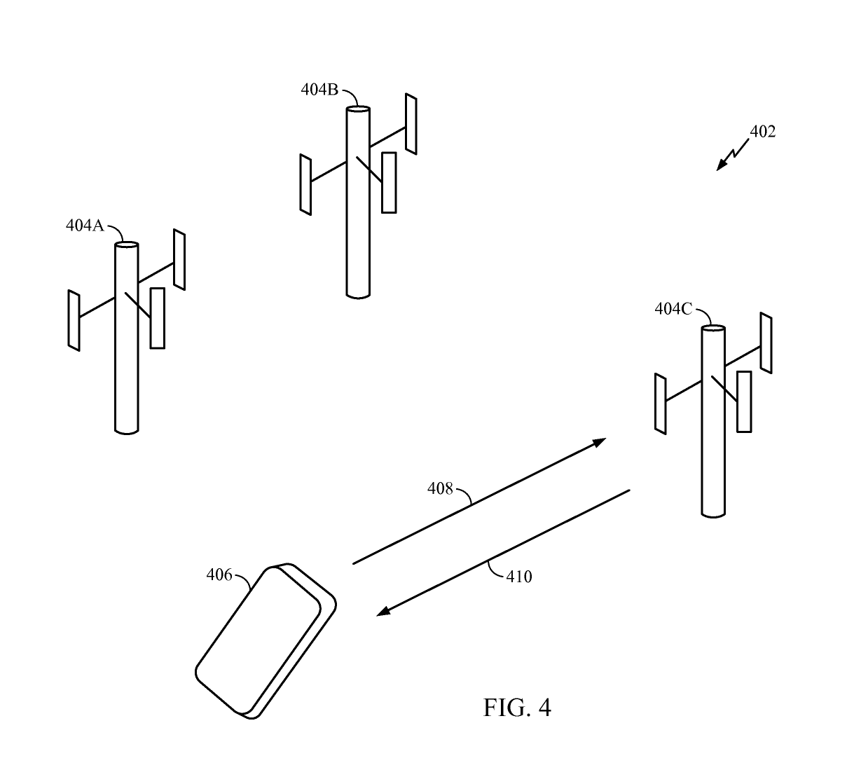

FIG. 4 illustrates a wireless communication system in which embodiments may find application. FIG. 4 illustrates a wireless communication network 402 comprising base stations 404A, 404B, and 404C. FIG. 4 shows a communication device, labeled 406, which may be a mobile communication device such as a cellular phone, a tablet, or some other kind of communication device suitable for a cellular phone network, such as a computer or computer system. The communication device 406 need not be mobile. In the particular example of FIG. 4, the communication device 406 is located within the cell associated with the base station 404C. Arrows 408 and 410 pictorially represent the uplink channel and the downlink channel, respectively, by which the communication device 406 communicates with the base station 404C.

Embodiments may be used in data processing systems associated with the communication device 406, or with the base station 404C, or both, for example. FIG. 4 illustrates only one application among many in which the embodiments described herein may be employed.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the disclosure can include a computer readable media embodying a method for live non-visual feedback during predictive text keyboard operation. Accordingly, the disclosure is not limited to illustrated examples and any means for performing the functionality described herein are included in embodiments of the disclosure.

While the foregoing disclosure shows some illustrative embodiments, it should be noted that various changes and modifications could be made herein without departing from the scope of the appended claims. The functions, steps and/or actions of the method claims in accordance with the embodiments described herein need not be performed in any particular order. Furthermore, although some elements may be described or claimed in the singular, the plural is contemplated unless limitation to the singular is explicitly stated.

What is claimed is:

1. A method to provide feedback with a device having a soft keyboard, the method comprising:
generating a confidence level based on receiving a set of taps or locus of sensed positions on the soft keyboard;
generating a set of candidate words in a dictionary based on the set of taps or locus of sensed positions;
generating the confidence level as a function of the size of the set of candidate words; and
providing feedback with the device based on the generated confidence level.

2. The method of claim 1, further comprising:
determining a set of soft keys associated with the set of taps or locus of sensed positions on the soft keyboard, each soft key having a center and associated with a position in the set of taps or locus of sensed positions;
determining a set of distances based on distances from the centers in the set of soft keys to associated positions in the set of taps or locus of sensed positions; and
generating the confidence level as a function of the set of distances.

3. The method of claim 2, further comprising:
providing a first type of feedback if the confidence level is less than a first threshold; and
providing a second type of feedback if the confidence level is greater than a second threshold.

4. The method of claim 2, further comprising:
vibrating the device from a first side of the device to a second side of the device as a function of the confidence level.

5. The method of claim 1, further comprising:
determining a set of soft keys associated with the set of taps or locus of sensed positions on the soft keyboard, each soft key having a center and associated with a position in the set of taps or locus of sensed positions;
determining a set of distances based on distances from the centers in the set of soft keys to associated positions in the set of taps or locus of sensed positions; and
generating the confidence level as a function of the set of distances.

6. The method of claim 1, further comprising:
providing a first type of feedback if the confidence level is less than a first threshold; and
providing a second type of feedback if the confidence level is greater than a second threshold.

7. The method of claim 6, wherein the first type of feedback comprises a vibration of a first side of the device, and the second type of feedback comprises a vibration of a second side of the device.

8. The method of claim 1, wherein the feedback is non-visual.

9. The method of claim 1, wherein the device is selected from the group consisting of a cellular phone, a tablet, and a computer.

10. An apparatus comprising:
at least one processor;
a display;
a haptic feedback unit; and
a memory to store instructions that when executed by the at least one processor cause the apparatus to perform a procedure comprising:
generating a confidence level based on receiving a set of taps or locus of sensed positions on a soft keyboard displayed on the display;
generating a set of candidate words in a dictionary based on the set of taps or locus of sensed positions;
generating the confidence level as a function of the size of the set of candidate words; and
providing feedback with the haptic feedback unit based on the generated confidence level.

11. The apparatus of claim 10, the haptic feedback unit comprising a vibrator motor, the feedback comprising vibration from the vibrator motor.

12. The apparatus of claim 10, the procedure performed by the apparatus further comprising:
determining a set of soft keys associated with the set of taps or locus of sensed positions on the soft keyboard, each soft key having a center and associated with a position in the set of taps or locus of sensed positions;
determining a set of distances based on distances from the centers in the set of soft keys to associated positions in the set of taps or locus of sensed positions; and
generating the confidence level as a function of the set of distances.

13. The apparatus of claim 10, the procedure performed by the apparatus further comprising:
providing a first type of feedback if the confidence level is less than a first threshold; and
providing a second type of feedback if the confidence level is greater than a second threshold.

14. The apparatus of claim 10, the procedure performed by the apparatus further comprising:
vibrating the apparatus from a first side of the apparatus to a second side of the apparatus as a function of the confidence level.

15. A non-transitory computer readable medium having stored instructions that when executed by at least one processor cause a device to perform a method comprising:
generating a confidence level based on receiving a set of taps or locus of sensed positions on a soft keyboard displayed on the device; generating a set of candidate words in a dictionary based on the set of taps or locus of sensed positions;
generating the confidence level as a function of the size of the set of candidate words; and
providing feedback with the device based on the generated confidence level.

16. The non-transitory computer readable medium of claim 15, the method further comprising:
determining a set of soft keys associated with the set of taps or locus of sensed positions on the soft keyboard, each soft key having a center and associated with a position in the set of taps or locus of sensed positions;
determining a set of distances based on distances from the centers in the set of soft keys to associated positions in the set of taps or locus of sensed positions; and
generating the confidence level as a function of the set of distances.

17. The non-transitory computer readable medium of claim 16, the method further comprising:
providing a first type of feedback if the confidence level is less than a first threshold; and
providing a second type of feedback if the confidence level is greater than a second threshold.

18. The non-transitory computer readable medium of claim 17, wherein the first and second types of feedback are non-visual.

19. The non-transitory computer readable medium of claim 16, the method further comprising:
vibrating the device from a first side of the device to a second side of the device as a function of the confidence level.

20. The non-transitory computer readable medium of claim 15, wherein the feedback is non-visual.

21. An apparatus with a soft keyboard to provide feedback, the apparatus comprising:
means for generating a confidence level, the confidence level based on receiving a set of taps or locus of sensed positions on the soft keyboard;
means for generating a set of candidate words in a dictionary, the candidate words based on the set of taps or locus of sensed positions, wherein the confidence level is a function of the size of the set of candidate words; and
means for providing feedback, the feedback based on the generated confidence level.

22. The apparatus of claim 21, further comprising:
means for determining a set of soft keys, the set of soft keys associated with the set of taps or locus of sensed positions on the soft keyboard, each soft key having a center and associated with a position in the set of taps or locus of sensed positions; and
means for determining a set of distances, the set of distances based on distances from the centers in the set of soft keys to associated positions in the set of taps or locus of sensed positions, wherein the confidence level is a function of the set of distances.

23. The apparatus of claim 22, further comprising:
means for providing a first type of feedback, the first type of feedback provided if the confidence level is less than a first threshold; and
means for providing a second type of feedback, the second type of feedback provided if the confidence level is greater than a second threshold.

24. The apparatus of claim 22, further comprising:
means for vibrating, the means for vibrating to vibrate the apparatus from a first side of the apparatus to a second side of the apparatus as a function of the confidence level.

25. The apparatus of claim 21, further comprising:
means for determining a set of soft keys, the set of soft keys associated with the set of taps or locus of sensed positions on the soft keyboard, each soft key having a center and associated with a position in the set of taps or locus of sensed positions; and
means for determining a set of distances, the set of distances based on distances from the centers in the set of soft keys to associated positions in the set of taps or locus of sensed positions, wherein the confidence level is a function of the set of distances.

26. The apparatus of claim 21, further comprising:
means for providing a first type of feedback, the first type of feedback provided if the confidence level is less than a first threshold; and
means for providing a second type of feedback, the second type of feedback provided if the confidence level is greater than a second threshold.

27. The apparatus of claim 26, wherein the first type of feedback comprises a vibration of a first side of the apparatus, and the second type of feedback comprises a vibration of a second side of the apparatus.

28. The method of claim 21, wherein the feedback is non-visual.

29. The method of claim 21, wherein the apparatus is selected from the group consisting of a cellular phone, a tablet, and a computer.
